(19) United States
(12) Patent Application Publication
(10) Pub. No.: US 2006/0005680 A1
(43) Pub. Date: Jan. 12, 2006

(54) Miter gauge assembly for table saw

(76) Inventors: Robert S. Gehret, Hampstead, MD (US); Paul M. Embree, Baltimore, MD (US); Robert Kusmierski, Felton, PA (US); Adan Ayala, Baltimore, MD (US)

Correspondence Address: THE BLACK & DECKER CORPORATION, 701 EAST JOPPA ROAD, TW199, TOWSON, MD, 21286, US

(21) Appl. No.: 11/175,738

(22) Filed: Jul. 6, 2005

Related U.S. Application Data
(60) Provisional application No. 60/586,130, filed on Jul. 7, 2004.

(51) Int. Cl. B23D 19/00; B26D 1/14

(52) U.S. Cl. 83/471.3

(57) ABSTRACT

A power tool with a base assembly and a table supported by the base assembly. The table has a slot. A saw assembly is pivotably supported by the table, and includes a motor, and a blade driven by the motor. A miter gauge assembly is disposable on the slot. The miter gauge assembly has a body, a fence pivotably attached to the body, and a bar pivotably attached to the body, where the bar is disposable in the slot.

### CROSS-REFERENCE TO RELATED APPLICATION

The present application derives priority under 35 USC § 119(e) from U.S. Application Ser. No. 60/586,130, filed Jul. 7, 2004.

### FIELD OF THE INVENTION

This invention relates generally to a miter gauge assembly for a table saw and more specifically to a miter gauge assembly for a combination table/miter saw.

### BACKGROUND OF THE INVENTION

Typical table saws have a miter gauge assembly to push a workpiece into the blade at a miter angle. Such typical miter gauge assembly is bulky and difficult to store. It is an object of the invention to provide a miter gauge assembly that is easy to store.

### SUMMARY OF THE INVENTION

In accordance with the present invention, an improved miter gauge assembly is employed. The power tool has a base assembly, a table supported by the base assembly, the table having a slot, a saw assembly pivotably supported by the table, the saw assembly including a motor, and a blade driven by the motor, the blade is substantially parallel to the slot, and a miter gauge assembly disposable on the slot, the miter gauge assembly comprising a body, a fence pivotably attached to the body, and a bar pivotably attached to the body, the bar being disposable in the slot.

Additional features and benefits of the present invention are described, and will be apparent from, the accompanying drawings and the detailed description below.

### BRIEF DESCRIPTION OF THE DRAWINGS

The accompanying drawings illustrate preferred embodiments of the invention according to the practical application of the principles thereof, and in which:

FIG. 1 illustrates a combination table/miter saw according to the invention, whereas FIGS. 1A-1B are side views of the combination table/miter saw in the miter saw and table saw modes, respectively; and

FIG. 2 illustrates a miter gauge assembly according to the invention, where FIG. 2A is a partial top plan view of the miter gauge assembly, and FIG. 2B is a cross-sectional view along lines B-B of FIG. 2A.

### DETAILED DESCRIPTION

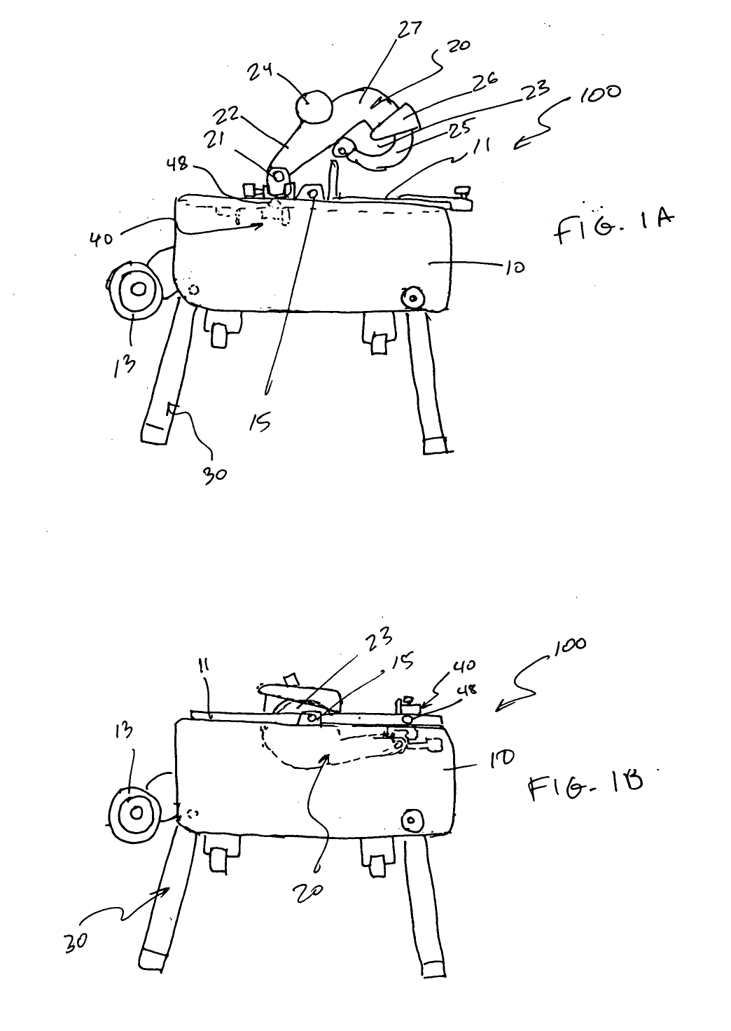

The invention is now described with reference to the accompanying figures, wherein like numerals designate like parts. Referring to FIG. 1, a combination table/miter saw 100 may include a base assembly 10, a table assembly 11 supported by base assembly 10, and a saw assembly 20 supported by the table assembly 11. Saw assembly 20 may include a trunnion assembly 21 disposed on the table assembly 11, a pivotable arm 22 pivotably attached to trunnion assembly 21, a motor 24 supported by the arm 22 and driving a blade 23. Arm 22 also supports upper blade guard 27, which covers an upper part of blade 23. Lower blade guard 25 is pivotally attached to upper blade guard 27. An auxiliary blade guard 26 may be pivotably connected to lower blade guard 25.

Preferably, table assembly 11 is pivotally attached to base assembly 10 via joint 15 so that, when the table assembly 11 is in the orientation of FIG. 1A, the saw assembly 20 can act as a miter saw, i.e., saw assembly 20 can be pivoted downwardly towards table assembly 11 to cut a workpiece placed on table assembly 11.

On the other hand, when table assembly 11 is rotated via joint 15 to the orientation of FIG. 1B, the saw 100 acts as a table saw, i.e., saw assembly 20 will be supported by and disposed underneath the table assembly 11. In such orientation, blade 23 extends through the table assembly 11, so that a user can dispose a workpiece on table assembly 11 and push it towards blade 23 for cutting.

Persons skilled in the art will recognize that the invention described below can be applicable to non-combined table saws.

Preferably, base assembly 10 has at least one wheel 13 thereon.

Base assembly 10 may also support four leg assemblies 30. Preferably leg assemblies 30 are pivotally attached to base assembly 10.

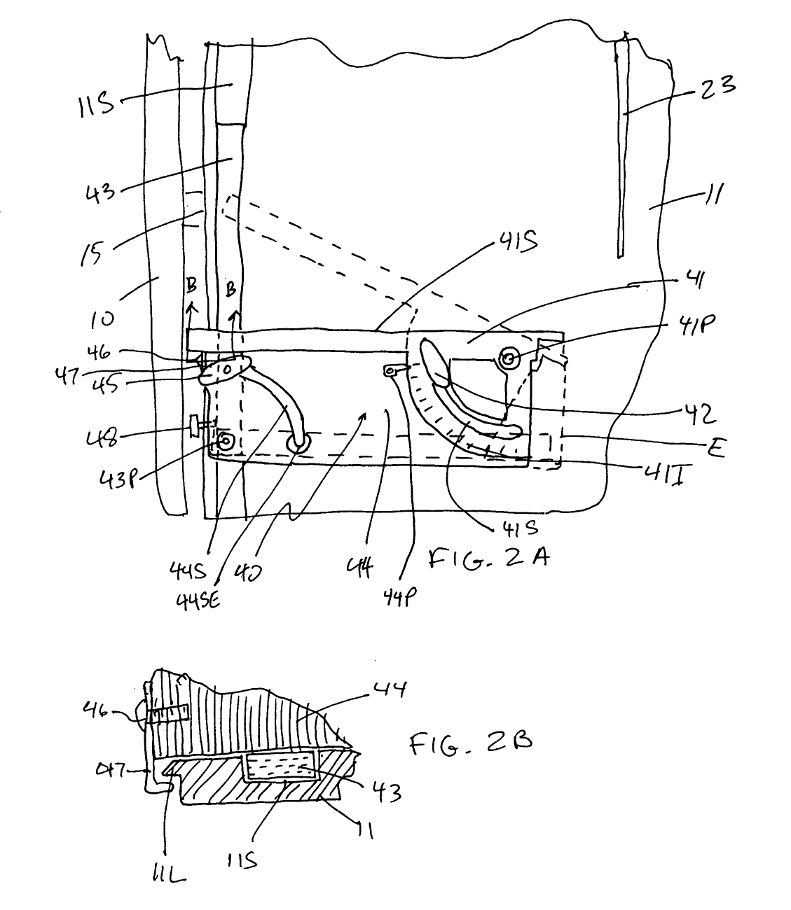

Referring to FIG. 2, miter gauge assembly 40 may be disposed on table 11. Miter gauge assembly 40 preferably includes a body 44. A fence 41 may be pivotably attached to body 44 via pivot joint 41P. Preferably, fence 41 has a workpiece supporting surface 41S which is substantially perpendicular to table 11.

Fence 41 may have an arcuate slot 41S. Slot 41S preferably has a center of curvature substantially coincident with pivot 41P.

A knob 42 may have a screw (not shown) extending through slot 41S, threadingly engaging body 41, and sandwiching fence 41 therebetween. With such arrangement, the user can change the angular position of fence 41 (and thus of workpiece supporting surface 41S) relative to body 44 by rotating fence 41. To fix the angular position of fence 41, the user need only tighten knob 42.

Persons skilled in the art will recognize it is preferable to provide angle indicia 41I on fence 41. Body 44 may carry a pointer 44P to interact with indicia 41I to indicate the angular position of fence 41. Persons skilled in the art will recognize that pointer 44P and indicia 41I can alternatively be placed on fence 41 and body 44P, respectively.

A bar 43 may be pivotally attached to body 44 via pivot 43P. Bar 43 is preferably disposable on a slot 11S that extends along table 11 substantially parallel to blade 23.

An arcuate slot 44S extends through body 44. Slot 44S preferably has a center of curvature substantially coincident with pivot 43P.

A handle 45 has a screw extending through slot 44S and threadingly engaging bar 43. Persons skilled in the art will recognize that body 44 is preferable sandwiched between handle 45 and bar 43.

Preferably bar 43 is pivotable between an extended position (shown in solid lines in FIG. 2A) and a retracted position (shown in broken lines in FIG. 2A). Body 44 preferably has two depressed slot ends 44SE to enable the user to quickly find the extended and/or retracted position. Preferably, slot ends 44SE are disposed at the ends of slot 44S.

These slot ends 44SE are lower than the portion of body 44 along slot 44S. Accordingly, the handle 45 will move into such depressed area. In order to pivot bar 43, the user will have to release handle 45 to such an extent that handle 45 can clear the portion of body 44 along slot 44. Otherwise, handle 45 will not permit rotation of bar 43.

Persons skilled in the art will recognize that such arrangement allows the user to fold bar 43 into body 44. In particular, if body 44 is substantially rectangular and substantially within an envelope E, which is defined by the largest width and depth of miter gauge assembly 40, bar 43 will not extend beyond envelope E when in the retracted position. Such compact arrangement facilitates transportation and storage of miter gauge assembly 40.

Referring to FIGS. 1-2, body 44 may have a hook 47 attached thereon via a screw 46. Hook 47 preferably engages a lip 11L of table 11. Hook 47 prevents the user from vertically lifting miter gauge assembly 40 when miter gauge assembly 40 is disposed on table 11.

Table 11 may have a lock 48 threadingly engaged to table 11. Lock 48 may contact bar 43, pushing it into locking contact with slot 11S.

Because miter gauge assembly 40 may be locked to table 11 in such manner, the user can change the mode of saw 100 without having to remove or separately store miter gauge assembly 40.

Persons skilled in the art may recognize other additions or alternatives to the means disclosed herein. However, all these additions and/or alterations are considered to be equivalents of the present invention.

We claim:

1. A power tool comprising:
a base assembly;
a table supported by the base assembly, the table having a slot;
a saw assembly pivotably supported by the table, the saw assembly including a motor, and a blade driven by the motor, the blade being substantially parallel to the slot; and
a miter gauge assembly disposable on the slot, the miter gauge assembly comprising a body, a fence pivotably attached to the body, and a bar pivotably attached to the body, the bar being disposable in the slot.

2. The power tool of claim 1, wherein the miter gauge assembly further comprises a locking knob extending through the fence and threadingly engaged to the body.

3. The power tool of claim 1, wherein the fence is substantially perpendicular to table.

4. The power tool of claim 1, wherein one of the body and the fence has a pointer and the other of the body and the fence has indicia interacting with the pointer to indicate the angular position of the fence relative to the body.

5. The power tool of claim 1, wherein the miter gauge assembly further comprises a locking knob extending through the body and threadingly engaged to the bar.

6. The power tool of claim 1, further comprising a locking knob threadingly engaged to the table and movable between a first position where the bar is moved into locking contact with the slot and a second position where the bar is not in locking contact with the slot.

7. The power tool of claim 1, wherein the body has a hook engaging the table to prevent lifting off of the miter gauge assembly.

8. A miter gauge assembly comprising:
a body;
a fence pivotably attached to the body; and
a bar pivotably attached to the body.

9. The assembly of claim 8, further comprising a locking knob extending through the fence and threadingly engaged to the body.

10. The assembly of claim 8, wherein the locking knob extends through an arcuate slot in the fence.

11. The assembly of claim 8, wherein one of the body and the fence has a pointer and the other of the body and the fence has indicia interacting with the pointer to indicate the angular position of the fence relative to the body.

12. The assembly of claim 8, further comprising a locking knob extending through the body and threadingly engaged to the bar.

13. The assembly of claim 12, wherein the locking knob extends through an arcuate slot in the body.

14. The assembly of claim 8, wherein the body has a downwardly-extending hook.
